(19) United States
(12) Patent Application Publication
(10) Pub. No.: US 2026/0291067 A1
(43) Pub. Date: Sep. 24, 2026

(54) ULTRA-WIDEBAND RADIATING ELEMENTS FOR MULTIBAND ANTENNAS

(71) Applicant: Outdoor Wireless Networks LLC, Richardson, TX (US)

(72) Inventors: Haiyan Chen, Suzhou (CN); Fangwen Wan, Suzhou (CN); Hangsheng Wen, Suzhou (CN)

(21) Appl. No.: 19/565,749

(22) Filed: Mar. 13, 2026

(30) Foreign Application Priority Data
Mar. 20, 2025 (CN) 202510335958.4

(51) Int. Cl. H01Q 5/48; H01Q 21/06

(52) U.S. Cl. CPC H01Q 5/48; H01Q 21/062

(57) ABSTRACT

A radiating element comprises a first dipole radiator that includes a first dipole arm and a second dipole arm, a second dipole radiator that includes a third dipole arm and a fourth dipole arm, and a coupling ring that adjacent the radiator unit. The first dipole arm is separated from the fourth dipole arm by a first slot, the fourth dipole arm is separated from the second dipole arm by a second slot, the second dipole arm is separated from the third dipole arm by a third slot, and the third dipole arm is separated from the first dipole arm by a fourth slot. The coupling ring includes a first metal stub that extends into the first slot, a second metal stub that extends into the second slot, a third metal stub that extends into the third slot, and a fourth metal stub that extends into the fourth slot.

### CROSS-REFERENCE TO RELATED APPLICATION

The present application claims priority under 35 U.S.C. § 119 to Chinese Patent Application Serial No. 202510335958.4, filed Mar. 20, 2025, the entire content of which is incorporated herein by reference as if set forth in its entirety.

### FIELD

The present invention relates to cellular communications systems and, more particularly, to base station antennas that operate in multiple different frequency bands.

### BACKGROUND

Cellular communications systems are known in the art. In a cellular communications system, a geographic area is divided into a series of regions that are referred to as “cells” which are served by respective macrocell base stations. Typically, a cell may serve users who are within a distance of, for example, 2-20 kilometers from the base station, although smaller cells are often used in urban and suburban areas to increase capacity. Each macrocell base station includes one or more antennas that are configured to provide two-way radio frequency (“RF”) communications with mobile subscribers that are within the cell served by the base station. In one common configuration, each cell is divided into a plurality of hexagonally-shaped regions or “sectors” that each span an arc of 120° in the azimuth plane, and each macrocell base station includes three base station antennas that provide service to respective ones of the hexagonally-shaped sectors. The azimuth plane refers to a horizontal plane (i.e., a plane that is parallel to the plane defined by the horizon) that bisects a base station antenna.

Each macrocell base station antenna may include one or more “linear” phased arrays of radiating elements, where each linear array is a column (or staggered column) of radiating elements that is configured to generate radiation patterns (also referred to herein as “antenna beams”) that cover an entire 120° sector. Macrocell base station antennas also often include multi-column arrays of radiating elements that are connected to beamforming radios that are used to generate narrower, higher gain antenna beams that can be electronically steered throughout the sector.

In order to increase capacity, cellular operators have widely deployed so-called small cell base stations. A small cell base station refers to a low-power base station that may operate in the licensed and/or unlicensed spectrum that has a much smaller range than a typical macrocell base station. Small cell base stations have much smaller coverage areas than typical macrocell base stations, such that a small cell base station typically only provides service to users who are within, for example, hundreds of meters of the small cell base station. Herein, the term “small cell” is used broadly to refer to base stations that serve smaller areas than conventional macrocell base stations, and thus the term “small cell” encompasses small cell, microcell, picocell and other base stations that serve small geographic regions. Most small cell base stations include a single antenna that is designed to provide omnidirectional coverage in the azimuth plane. A small cell antenna may have linear arrays of radiating elements that point in multiple different directions so that the small cell base station provides omnidirectional coverage. The linear arrays may be fed individually to provide service to respective sectors (e.g., 90° or 120° sectors) in the azimuth plane or groups of linear arrays may be commonly fed so that omnidirectional antenna beams are generated (an “omnidirectional” antenna beam refers to an antenna beam that extends outwardly in all directions in the azimuth plane). Small cell base stations may be used, for example, to provide cellular coverage to high traffic areas within a macrocell, which allows a macrocell base station to offload much or all of the traffic in the vicinity of a small cell to the small cell base station.

Cellular operators are also adding cellular service in a variety of new frequency bands. While in some cases it is possible to use a single array of so-called “wideband” radiating elements to provide service in multiple frequency bands, in other cases it is necessary to use different arrays of radiating elements to support service in the different frequency bands. Accordingly, most modern base station antennas are multi-band antennas that include arrays of radiating elements that operate in different operating frequency bands. For example, base station antennas are now being deployed that include at least two of (1) arrays of “low-band” radiating elements that operate in some or all of the 694-960 MHz frequency range (or, in some jurisdictions, the expanded 617-960 MHz frequency range), (2) arrays of “mid-band” radiating elements that operate in some or all of the 1695-2690 MHz frequency range (or, in some jurisdictions, the expanded 1427-2690 MHz frequency range), and (3) arrays of high-band radiating elements that operate in some or all of, for example, the 3.1-4.2 GHz frequency band.

With the introduction of 4G and 5G cellular technologies, base stations now routinely employ radios and antennas that have multi-input-multi-output (“MIMO”) capabilities. MIMO refers to a technique where a data stream that is to be transmitted is divided into multiple sub-components that are used to generate multiple RF signals that are simultaneously transmitted to a receiving device. The RF signals are transmitted using antenna arrays that are spatially separated from one another and/or at orthogonal polarizations to ensure that the RF signals are sufficiently decorrelated from one another. The receiving device recovers the multiple data streams from the received RF signals and reconstructs the original data stream. The use of MIMO transmission techniques may help overcome the negative effects of multipath fading, reflections and the like to provide enhanced transmission quality and capacity. Since small antennas may include multiple linear arrays (to support MIMO communications) and may operate in multiple frequency bands (to increase capacity), the number of linear arrays and RF ports included in many modern small cell antennas is increasing.

### SUMMARY

Pursuant to some embodiments of the present invention, radiating elements are provided that comprise a radiator unit and a coupling ring. The radiator unit includes a first dipole radiator that has a first dipole arm and a second dipole arm and a second dipole radiator that has a third dipole arm and a fourth dipole arm. The coupling ring is adjacent the radiator unit, and includes a metal ring and a first through fourth metal stubs that extend inwardly from the metal ring. The first dipole arm is separated from the fourth dipole arm by a first slot, the fourth dipole arm is separated from the second dipole arm by a second slot, the second dipole arm is separated from the third dipole arm by a third slot, and the third dipole arm is separated from the first dipole arm by a fourth slot. In addition, the first metal stub overlaps the first slot in the forward direction, the second metal stub overlaps the second slot in the forward direction, the third metal stub overlaps the third slot in the forward direction, and the fourth metal stub overlaps the fourth slot in the forward direction.

In some embodiments, each of the first through fourth dipole arms comprises a metal loop, and each of the first through fourth dipole arms is positioned next to two other of the first through fourth dipole arms so that a perimeter defined by the first through fourth dipole arms has a square shape when viewed from the front. In some embodiments, the square shape has beveled corners.

In some embodiments, the coupling ring is spaced apart from the radiator unit in a forward direction, and the coupling ring does not overlap the first dipole radiator or the second dipole radiator in the forward direction.

In some embodiments, a central opening of the coupling ring has a square shape, and the first through fourth metal stubs extend inwardly from respective first to fourth inner sides of the coupling ring. In some embodiments, the radiating element may further comprise fifth through eighth metal stubs that extend inwardly from the respective first to fourth inner sides of the coupling ring. In such embodiments, the first through eighth metal stubs may have longitudinal axes that extend inwardly at angles of 0°, 45°, 90°, 135°, 180°, −135°, −90° and −45°, respectively.

In some embodiments, a central opening of the coupling ring has a circular shape, and the first through fourth metal stubs extend inwardly from a circular inner side of the coupling ring.

In some embodiments, the radiating element further comprises a feed stalk that has a longitudinal axis that extends in a forward direction, wherein the coupling ring is positioned forwardly of the radiator unit. In other embodiments, the coupling ring may be positioned rearwardly of the radiator unit.

In some embodiments, the radiating element may further comprise a director that is mounted forwardly of the radiator unit and the coupling ring. In some embodiments, the director may not overlap the coupling ring in a forward direction.

The first and second dipole radiators may, for example, each exhibit a return loss of less than −10 dB over the 1695-2690 MHz and the 3.1-4.2 GHz frequency bands.

In some embodiments, the first dipole arm may comprise a first metal pad, a first metal trace that extends outwardly from a first side of the first metal pad, a second metal trace that extends outwardly from a second side of the first metal pad, the second side opposite the first side, and a second metal pad that is positioned outwardly of the first metal pad and electrically connected to the first metal pad through the first and second metal traces. In such embodiments, an outer side of the first metal pad may include a first slot where the metal is omitted and an inner side of the second metal pad may include a second slot where the metal is omitted. A longitudinal axis of the first slot may be collinear with a longitudinal axis of the second slot. The radiating element may further comprise a feed stalk, and the radiator unit may be mounted on the feed stalk, and the first metal pad may include a third slot, and a tab on the feed stalk extends through the third slot. A longitudinal axis of the third slot may also be collinear with a longitudinal axis of the first slot.

In some embodiments, an outer side of the first metal pad may further includes first and second tapered slots where the metal is omitted, and the first slot may be in between the first and second tapered slots. In some embodiments, the first slot may have a first length, and the first and second tapered slots may each have a second length that is longer than the first length.

In some embodiments, the radiator unit defines a first plane and the coupling ring defines a second plane that is parallel to the first plane.

Pursuant to further embodiments of the present invention, radiating elements are provided that include a feed stalk, a radiator unit and a coupling ring. The radiator unit is mounted on a forward end of the feed stalk and comprises a first dipole radiator that has a first dipole arm and a second dipole arm and a second dipole radiator that has a third dipole arm and a fourth dipole arm. The coupling ring has an outer perimeter that has a first shape when viewed from the front and a central opening that has a second shape when viewed from the front, where the second shape is different than the first shape.

In some embodiments, the first shape is a square. In some embodiments, the second shape is a circle.

In some embodiments, the first dipole arm is separated from the second dipole arm by a first slot, the second dipole arm is separated from the third dipole arm by a second slot, the third dipole arm is separated from the fourth dipole arm by a third slot, and the fourth dipole arm is separated from the first dipole arm by a fourth slot. In such embodiments, the coupling ring may include a ring section and first through fourth metal stubs that extend inwardly from the ring section, where the first metal stub overlaps the first slot in the forward direction, the second metal stub that overlaps the second slot in the forward direction, the third metal stub that overlaps the third slot in the forward direction, and the fourth metal stub that overlaps the fourth slot in the forward direction. In some embodiments, the coupling ring may further comprise fifth through eighth metal stubs that extend inwardly from the inner sides of the ring section. The first through eighth metal stubs have longitudinal axes that extend inwardly at angles of 0°, 45°, 90°, 135°, 180°, −135°, −90° and −45°, respectively.

In some embodiments, the coupling ring is spaced apart from the radiator unit in a forward direction, and the coupling ring does not overlap the first dipole radiator or the second dipole radiator.

In some embodiments, the radiating element may further comprise a director mounted forwardly of the radiator unit and the coupling ring. The director may not overlap the coupling ring in a forward direction in some embodiments.

In some embodiments, both the first and second dipole radiators exhibit a return loss of less than −10 dB over the 1695-2690 MHz and the 3.1-4.2 GHz frequency bands.

Pursuant to still further embodiments of the present invention, radiating elements are provided that comprise a radiator unit that includes a first dipole radiator that has a first dipole arm and a second dipole arm and a second dipole radiator that has a third dipole arm and a fourth dipole arm. Each dipole arm comprises a first metal pad; a first metal trace that extends outwardly from a first side of the first metal pad; a second metal trace that extends outwardly from a second side of the first metal pad, the second side opposite the first side; and a second metal pad that is positioned outwardly of the first metal pad and electrically connected to the first metal pad through the first and second metal traces.

In some embodiments, an outer side of the first metal pad includes a first slot, and an inner side of the second metal pad includes a second slot. In some embodiments, a longitudinal axis of the first slot is collinear with a longitudinal axis of the second slot. In some embodiments, the radiating element may further comprise a feed stalk, where the radiator unit is mounted on the feed stalk, and where the first metal pad may include a third slot, and a tab on the feed stalk may extend through the third slot. In some embodiments, a longitudinal axis of the third slot may be collinear with a longitudinal axis of the first slot.

In some embodiments, an outer side of the first metal pad may further include first and second tapered slots where metal is omitted, and the first slot may be in between the first and second tapered slots. In some embodiments, the first slot may have a first length, and the first and second tapered slots may each have a second length that is longer than the first length.

In some embodiments, the radiating element may further comprise a metal coupling ring that is configured to capacitively couple with the first dipole radiator and the second dipole radiator. In such embodiments, the coupling ring may include a metal ring and a first through fourth metal stubs that extend inwardly from the metal ring. The first dipole arm may be separated from the fourth dipole arm by a first slot, the fourth dipole arm may be separated from the second dipole arm by a second slot, the second dipole arm may be separated from the third dipole arm by a third slot, and the third dipole arm may be separated from the first dipole arm by a fourth slot. The first metal stub may overlap the first slot in the forward direction, the second metal stub may overlap the second slot in the forward direction, the third metal stub may overlap the third slot in the forward direction, and the fourth metal stub may overlap the fourth slot in the forward direction.

In some embodiments, the coupling ring is spaced apart from the radiator unit in a forward direction, and the coupling ring may not overlap the first dipole radiator or the second dipole radiator.

In some embodiments, the coupling ring further comprises fifth through eighth metal stubs that extend inwardly from the inner sides of the metal ring. In some embodiments, the first through eighth metal stubs have longitudinal axes that extend inwardly at angles of 0°, 45°, 90°, 135°, 180°, −135°, −90° and −45°, respectively.

In some embodiments, the radiating element may further comprise a director mounted forwardly of the radiator unit and the coupling ring. The director may not overlap the coupling ring in a forward direction.

### BRIEF DESCRIPTION OF THE DRAWINGS

FIG. 1A is a highly simplified schematic diagram illustrating a small cell base station.

FIG. 1B illustrates an omnidirectional antenna beam that may be generated by the base station antenna of the small cell base station of FIG. 1A.

FIG. 2A is a schematic perspective view of a conventional small cell base station antenna (with its radome removed).

FIG. 2B illustrates the feed network for one of the sector mid-band arrays included in the base station antenna of FIG. 2A.

FIG. 2C illustrates the feed network for one of the omnidirectional mid-band arrays included in base station antenna of FIG. 2A.

FIGS. 2D and 2E are schematic diagrams that show how the radiating elements included in the conventional small cell base station antenna of FIG. 2A are grouped to form a plurality of arrays of radiating elements.

FIG. 3A is a schematic side view of an ultra-wideband radiating element according to embodiments of the present invention.

FIG. 3B is a schematic front view of the radiating element of FIG. 3A.

FIG. 3C is a greatly enlarged view of one of the dipole arms shown in FIG. 3B.

FIG. 4 is a schematic perspective view of a small cell base station antenna according to embodiments of the present invention with its radome removed.

FIGS. 5A and 5B are schematic front views of two additional ultra-wideband radiating elements according to embodiments of the present invention.

FIG. 5C is a schematic side view of an ultra-wideband radiating element according to still further embodiments of the present invention.

### DETAILED DESCRIPTION

Small cell base station antennas are typically much smaller than macrocell antennas, and are often designed to be mounted on utility poles. Cellular network operators are now requesting small cell antennas that have generate both omnidirectional and “sector” antenna beams to provide a good tradeoff between coverage and capacity. For some multiband small cell applications, this requires that the antenna have a large number of RF ports. In some cases the number of RF ports exceeds the available space on the end cap of the antenna for mounting RF ports. To overcome this problem, some RF ports may be multiplexed (meaning that RF signals in at least two different frequency bands are input through the same RF port, and then separated in the antenna using, for example, a diplexer). However, the addition of multiplexers adds insertion losses, increases the cost of the antenna and makes cable routing within the antenna more difficult, which can require increased cable lengths, leading to further insertion loss and extra expense. In addition, given the small size of typical small cell antennas, the spacing between adjacent arrays of radiating elements is typically very small, which can result in strong coupling between adjacent arrays, which makes return loss and isolation tuning difficult, and can degrade the shapes of the antenna beams, resulting in lower antenna gain.

It is known in the art to employ so-called wideband radiating elements in base station antennas that can be used to simultaneously support service in two different cellular frequency bands. For example, both the low-band and the mid-band cellular frequency ranges encompass frequencies that are used for a range of different cellular services. Most base station antennas include low-band radiating elements that can transmit and receive RF signals with low return loss over the full 694-960 MHz frequency range, allowing cellular operators to use the antenna to support any of the low-band cellular services, and include mid-band radiating elements that can transmit and receive RF signals with low return loss over the full 1695-2690 MHz frequency range, allowing cellular operators to use the antenna to support any of the mid-band cellular services. Moreover, in some cases the antenna will include diplexers so that one or more of the arrays of radiating elements may be used to simultaneously support two different types of cellular service that are within different sub-bands of the low-band frequency range or the mid-band frequency range.

Pursuant to embodiments of the present invention, ultra-wideband radiating elements are provided that can operate with low return loss over the 1695-4200 MHz frequency range. In other words, these radiating elements can operate over the full mid-band and high-band frequency ranges. When arrays of such radiating elements are used in antennas that include diplexers, the same linear arrays may be used to simultaneously support both mid-band and high-band cellular service, which may partially or fully eliminate any need for high-band linear arrays. Moreover, since each array of the radiating elements according to embodiments of the present invention may replace two arrays of a conventional antenna, the size of the antenna may be reduced and the spacing between columns can be increased, allowing the cost of the antenna to be reduced and the performance to be improved.

The radiating elements according to some embodiments of the present invention may be cross-dipole radiating elements that include a first dipole radiator that is configured to transmit and receive RF energy having a −45° slant polarization and a second dipole radiator that is configured to transmit and receive RF energy having a +45° slant polarization. These radiating elements may further include a metal coupling ring that is positioned either in front of or behind the dipole arms. The coupling ring is configured to expand the operating frequency range of the radiating element to lower frequencies than would otherwise be possible. Each radiating element may also includes a director that is mounted forwardly of both the dipole arms and the coupling ring. The director may be configured to expand the operating frequency range of the radiating element to higher frequencies than would otherwise be possible, and to improve the shape and gain of the antenna beams in the high-band operating frequency range.

Each dipole radiator may comprise a pair of center-fed dipole arms. Each dipole arm may have a generally square outer perimeter, and the four dipole arms of each radiating element may be positioned in the respective four quadrants of a larger square so that each dipole arm has another dipole arm immediately adjacent each of its inner sides. Slots may be defined between each pair of adjacent dipole arms. Moreover, the coupling ring may include a metal ring and at least four metal stubs that extend inwardly from the metal ring. The metal stubs may overlap the respective slots that are defined between the pairs of adjacent dipole arms in the forward direction. The metal stubs may improve the impedance match at lower frequencies, allowing the lower end of the operating frequency range of the radiating element to be expanded.

Example embodiments of the invention will now be discussed in more detail with reference to the attached drawings.

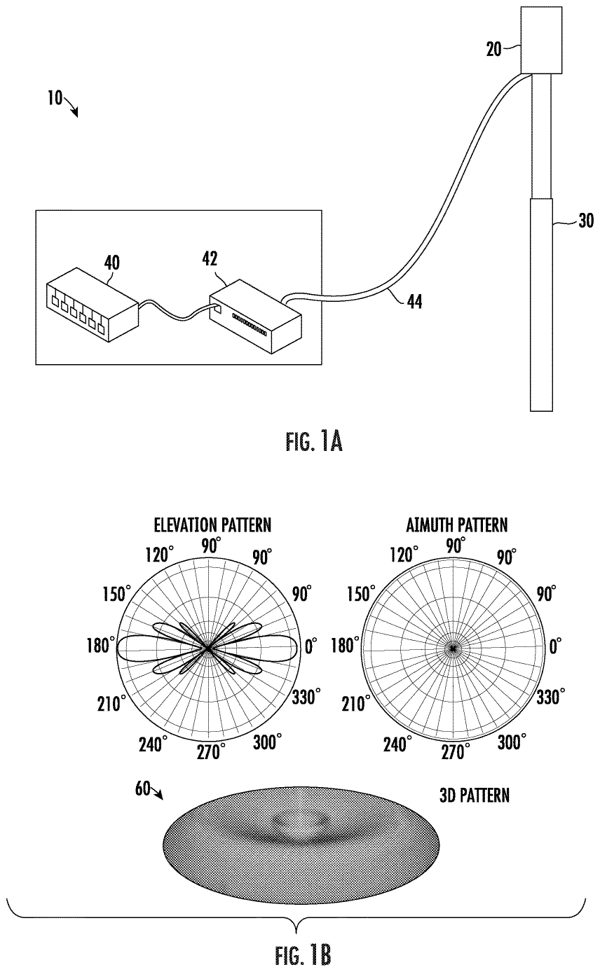

FIG. 1A is a schematic diagram of a conventional small cell base station 10. The base station 10 includes an antenna 20 that may be mounted on a mounting structure 30 which is shown as being a utility pole. The antenna beams generated by the antenna 20 may be omnidirectional in the azimuth plane, meaning that the antenna beams extend through a full 360° circle in the azimuth plane, and may have a suitable beamwidth (e.g., 10-30°) in the elevation (vertical) plane. The antenna beams generated by the antenna 20 may be slightly down-tilted in the elevation plane to reduce interference with adjacent base stations.

The small cell base station 10 further includes base station equipment such as baseband units 40 and radios 42. A single baseband unit 40 and a single radio 42 are shown in FIG. 1A to simplify the drawing, but it will be appreciated that more than one baseband unit 40 and/or radio 42 are typically provided. Additionally, while the radio 42 is shown as being co-located with the baseband equipment 40 at the bottom of the utility pole 30, in other cases the radio 42 may be a remote radio head that is mounted on the utility pole 30 directly adjacent the antenna 20 in order to reduce RF cable losses. As is known to those of skill in the art, the baseband unit 40 may receive data from another source such as, for example, a backhaul network (not shown) and may process this data and provide a data stream to the radio 42. The radio 42 may generate RF signals that include the data encoded therein and may amplify and deliver these RF signals to the antenna 20 for transmission via a cabling connection 44.

FIG. 1B is a composite of several views of an antenna beam 60 having an omnidirectional pattern in the azimuth plane that may be generated by the antenna 20. In particular, FIG. 1B includes a schematic three-dimensional view of the antenna beam 60 (labelled “3D pattern”) as well as plots of the azimuth and elevation patterns thereof. The azimuth pattern is generated by taking a horizontal cross-section through the middle of the three dimensional antenna beam 60, and the elevation pattern is generated by taking a vertical cross-section through the middle of the three dimensional beam 60. The three-dimensional pattern in FIG. 1B illustrates the general shape of the generated antenna beam in three dimensions. As can be seen, the antenna beam 60 extends through a full 360° in the azimuth plane, and the antenna beam 60 may have a nearly constant gain in all directions in the azimuth plane. In the elevation plane, the antenna beam 60 has a high gain near the horizon, but the gain drops off dramatically both above and below the horizon. The antenna beam 60 thus is omnidirectional in the azimuth plane and directional in the elevation plane.

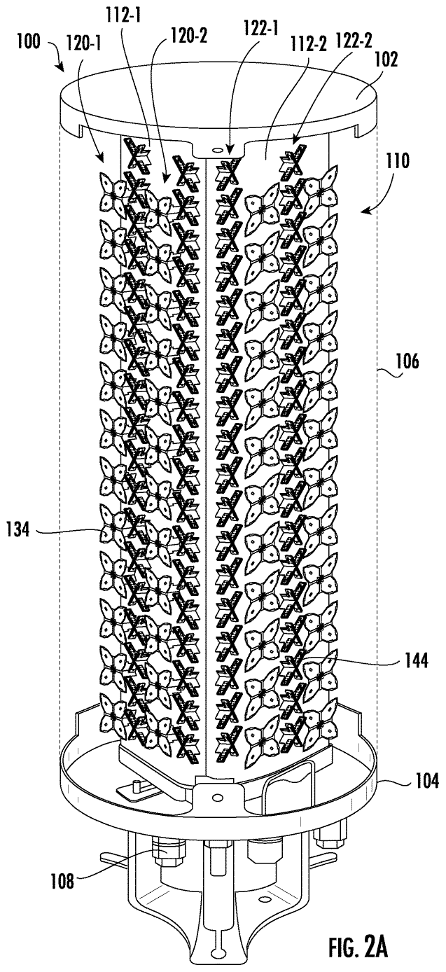

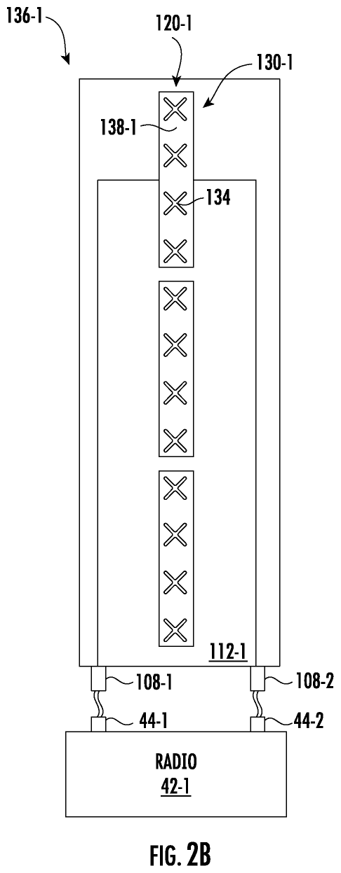

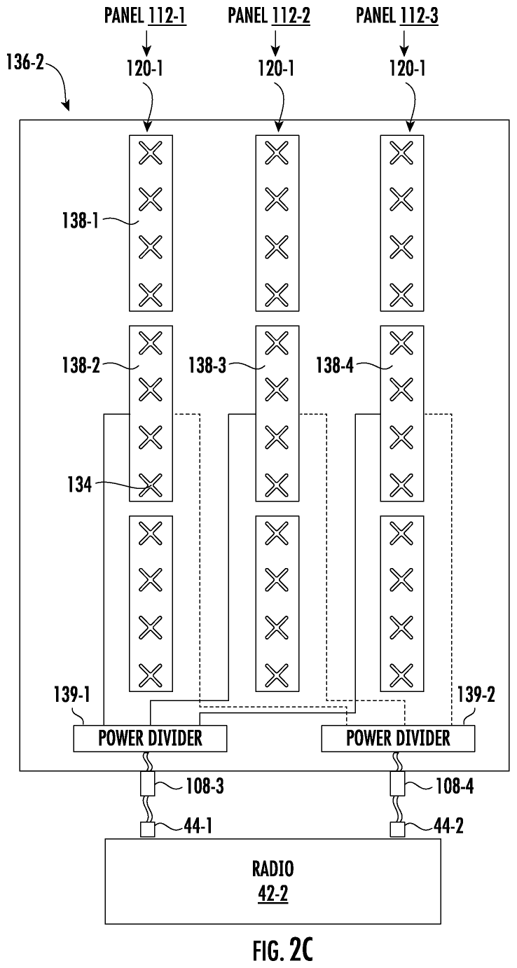

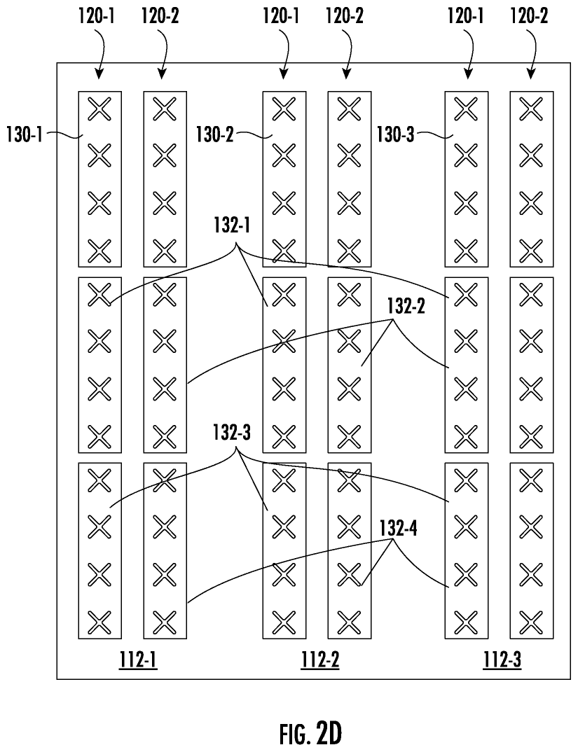

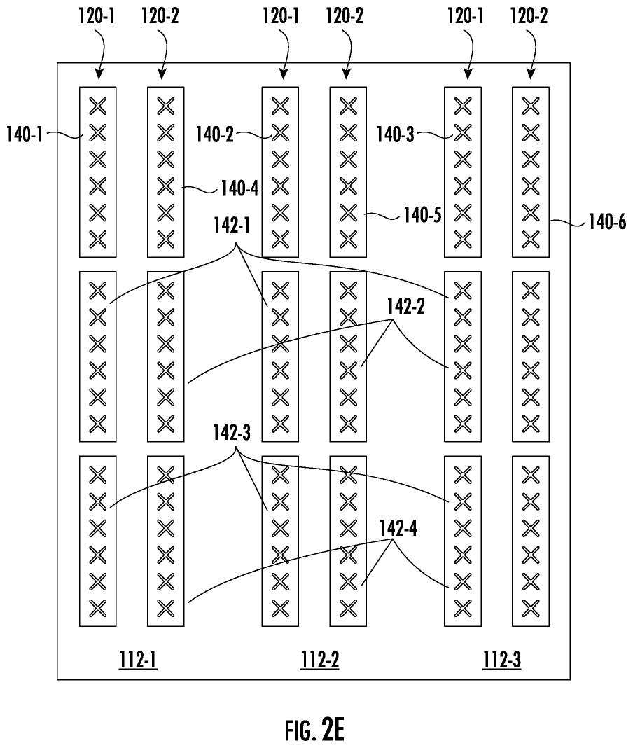

FIG. 2A is a schematic perspective view of a conventional small cell base station antenna 100 (with its radome removed).

Base station antenna 100 includes a top end cap 102 and a bottom end cap 104. A radome 106 (shown in shadow view) extends between the top and bottom end caps 102, 104 to cover and protect the internal components of the antenna 100. The radome 106 may comprise a substantially cylindrical radome and may be substantially transparent to RF radiation in the operating frequency bands of base station antenna 100. A plurality of RF ports 108 are mounted in the bottom end cap 104.

Base station antenna 100 further includes a triangular reflector assembly 110 that includes three reflector panels 112-1 through 112-3 (also referred to herein as “panels” and “reflectors”) that are arranged to define a tube having horizontal cross-sections that define equilateral triangles. Only two of the panels 112 are visible in FIG. 2A. Two columns 120-1, 120-2 of mid-band radiating elements 134 (referred to herein as “mid-band columns” 120) and two columns 122-1, 122-2 of high-band radiating elements 144 (referred to herein as “high-band columns” 122) are mounted on each of the three panels 112 so that base station antenna 100 includes twelve columns of radiating elements 134, 144. Each panel 112 of the tubular triangular reflector assembly 110 may comprise a reflector that serves as a ground plane for the radiating elements 134, 144 mounted thereon, and the panels 112 may comprise a unitary structure or may comprise a plurality of structures that are (directly or indirectly) attached together. Herein, when multiple like or similar elements are provided they may be labelled in the drawings using a two part reference numeral. Such elements may be referred to herein individually by their full reference numeral (e.g., the panel 112-2) and may be referred to collectively by the first part of their reference numeral (e.g., the panels 112).

FIG. 2D is a schematic diagram that illustrates the two mid-band columns 120-1, 120-2 that are mounted on each of the three reflector panels 112-1 through 112-3, and shows how the mid-band radiating elements 134 in these six mid-band columns 120 are arranged into different arrays of radiating elements. As shown in FIG. 2D, each mid-band column 120-1, 120-2 includes three separate groups of mid-band radiating elements 134. These groups of mid-band radiating elements 134 form a total of ten arrays. In particular, the upper group of four mid-band radiating elements 134 in the first mid-band column 120-1 forms a first “sector” mid-band linear array 130-1 that provides service to the 120° sector that is located outwardly of the first panel 112-1. The upper groups of four mid-band radiating elements 134 in the first mid-band columns 120-1 on the second and third panels 112-2, 112-3 similarly form second and third “sector” mid-band linear arrays 130-2, 130-3 that provide service to the respective 120° sectors that are located outwardly of the second and third panels 112-2, 112-3. The middle group of four mid-band radiating elements 134 in the first mid-band column 120-1 on panel 112-1, together with the middle groups of four mid-band radiating elements 134 in the first mid-band columns 120-1 that are mounted on the second and third panels 112-2, 112-3, form a first omnidirectional mid-band array 132-1 that provides omnidirectional service. The lower group of four mid-band radiating elements 134 in the first mid-band column 120-1 on panel 112-1, together with the lower groups of four mid-band radiating elements 134 in the first mid-band columns 120-1 that are mounted on the second and third panels 112-2, 112-3, form a second omnidirectional mid-band array 132-2.

Still referring to FIG. 2D, the upper group of four mid-band radiating elements 134 in the second mid-band column 120-2 on panel 112-1 form a fourth sector mid-band linear array 130-4. The upper groups of four mid-band radiating elements 134 in the second mid-band columns 120-2 on the second and third panels 112-2, 112-3 similarly form fifth and sixth sector mid-band linear arrays 130-5, 130-6. The middle group of four mid-band radiating elements 134 in the second mid-band column 120-2 on panel 112-1, together with the middle groups of four mid-band radiating elements 134 in the second mid-band columns 120-2 that are mounted on the second and third panels 112-2, 112-3, form a third omnidirectional mid-band array 132-3. The lower group of four mid-band radiating elements 134 in the second mid-band column 120-2 on panel 112-1, together with the lower groups of four mid-band radiating elements 134 in the second mid-band columns 120-2 that are mounted on the second and third panels 112-2, 112-3, form a fourth omnidirectional mid-band array 132-4.

FIG. 2E is a schematic diagram that illustrates the two high-band columns 122-1, 122-2 that are mounted on each of the three reflector panels 112-1 through 112-3, and shows how the high-band radiating elements 144 in these six mid-band columns 122 are arranged into different arrays of radiating elements. As shown in FIG. 2E, each high-band column 122-1, 122-2 includes three separate groups of high-band radiating elements 144. These groups of high-band radiating elements 134 also form a total of ten arrays. In particular, the upper group of four high-band radiating elements 144 in the first high-band column 122-1 forms a first sector high-band linear array 140-1 that provides service to the 120° sector that is located outwardly of the first panel 112-1. The upper groups of four high-band radiating elements 144 in the first high-band column 122-1 on the second and third panels 112-2, 112-3 similarly form second and third sector high-band linear arrays 140-2, 140-3 that provide service to the respective 120° sectors that are located outwardly of the second and third panels 112-2, 112-3. The middle group of four high-band radiating elements 144 in the first high-band column 122-1 on panel 112-1, together with the middle groups of four high-band radiating elements 144 in the first high-band columns 122-1 that are mounted on the second and third panels 112-2, 112-3, form a first omnidirectional high-band array 142-1. The lower group of four high-band radiating elements 144 in the first high-band column 122-1 on panel 112-1, together with the lower groups of four high-band radiating elements 144 in the first high-band columns 122-1 that are mounted on the second and third panels 112-2, 112-3, form a second omnidirectional high-band array 142-2.

Still referring to FIG. 2E, the upper group of four high-band radiating elements 144 in the second high-band column 122-2 on panel 112-1 forms a fourth sector high-band linear array 140-4, and the upper groups of four high-band radiating elements 144 in the second high-band columns 122-2 on the second and third panels 112-2, 112-3 similarly form fifth and sixth sector high-band linear arrays 140-5, 140-6. The middle group of four high-band radiating elements 144 in the second high-band column 122-2 on panel 112-1, together with the middle groups of four high-band radiating elements 144 in the second high-band columns 120-2 that are mounted on the second and third panels 112-2, 112-3, form a third omnidirectional high-band array 142-3. The lower group of four high-band radiating elements 144 in the second high-band column 122-2 on panel 112-1, together with the lower groups of four high-band radiating elements 144 in the second high-band columns 122-2 that are mounted on the second and third panels 112-2, 112-3, form a fourth omnidirectional high-band array 142-4.

Thus, as described above, base station antenna 100 includes six sector arrays 130 of mid-band radiating elements 134, four omnidirectional arrays 132 of mid-band radiating elements 134, six sector arrays 140 of high-band radiating elements 144, and four omnidirectional arrays 142 of high-band radiating elements 144. The mid-band and high-band radiating elements 134, 144 may each comprise, for example, slant −45°/+45° cross-dipole radiating elements that each include a first dipole radiator that is configured to transmit and receive RF signals having a −45° polarization and a second dipole radiator that is configured to transmit and receive RF signals having a +45° polarization. Since dual-polarization radiating elements 134, 144 are used, each array is coupled to two RF ports (one for each polarization). Thus, since antenna 100 includes twenty arrays, antenna 100 may include forty RF ports 108 that couple the arrays 130, 132, 140, 142 to ports of corresponding radios.

FIG. 2B illustrates the feed network 136-1 for the first sector mid-band array 130-1 of base station antenna 100, and FIG. 2C illustrates the feed network 150-2 for one of the mid-band omnidirectional arrays of base station antenna 100. It will be appreciated that all of the sector mid-band and high-band arrays 130, 140 included in base station antenna 100 will have the same feed network design and that all of the omnidirectional mid-band and high-band arrays 132, 142 included in base station antenna 100 will have the same feed network design. Thus, it is only necessary to discuss the design of the feed networks for one of the sector arrays 130, 140 and for one of the omnidirectional arrays 132, 142.

As shown in FIG. 2B, the feed network 136-1 may be used to pass RF signals between a base station radio 42-1 and the radiating elements 134 of the first mid-band sector array 130-1. First and second ports 44-1, 44-2 of a first radio 42-1 are connected to first and second RF ports 108-1, 108-2 of antenna 100 by respective RF transmission lines (e.g., coaxial cables). The first RF port 108-1 is connected to a first feedboard printed circuit board 138-1. The upper four mid-band radiating elements 134 of the first mid-band column 120-1 on the first panel 112-1 are mounted on the first feedboard printed circuit board 138-1 and together form the first mid-band sector array 130-1. The first feedboard printed circuit board 138-1 includes one or more first polarization power dividers (not shown) that split first polarization RF signals that are input to the first feedboard printed circuit board 138-1 into four sub-components that are passed to the first polarization radiators of the four respective mid-band radiating elements 134 mounted on the first feedboard printed circuit board 138-1. Similarly, the second RF port 108-2 is connected to the first feedboard printed circuit board 138-1, and the first feedboard printed circuit board 138-1 includes one or more second polarization power dividers (not shown) that split second polarization RF signals that are input to the first feedboard printed circuit board 138-1 into four sub-components that are passed to the second polarization radiators of the four respective mid-band radiating elements 134 mounted on the first feedboard printed circuit board 138-1.

Thus, RF signals output at radio port 44-1 may be transmitted into free space by the first polarization radiators of the uppermost four radiating elements in the first mid-band column 120-1 on reflector panel 112-1 to form a first antenna beam that provides coverage to a 120° sector that is outward of reflector panel 112-1. Similarly, RF signals output at radio port 44-2 may be transmitted into free space by the second polarization radiators of the uppermost four radiating elements in the first mid-band column 120-1 on reflector panel 112-1 to form a second antenna beam that provides coverage to the 120° sector that is outward of reflector panel 112-1.

As shown in FIG. 2C, a second feed network 136-2 may be used to pass RF signals between a base station radio and the radiating elements 134 of the first omnidirectional mid-band array 132-1. As shown in FIG. 2C, first and second ports 44-1, 44-2 of a second radio 42-2 are connected to third and fourth RF ports 108-3, 108-4 of antenna 100 by respective RF transmission lines (e.g., coaxial cables). The third RF port 108-3 is connected to an input of a first polarization 1×3 power divider 139-1. The three outputs of the first polarization power divider 139-1 are coupled to second through fourth feedboard printed circuit boards 138-2 through 138-4. The middle four mid-band radiating elements 134 of the first mid-band column 120-1 on the first panel 112-1 are mounted on the second feedboard printed circuit board 138-2, the middle four mid-band radiating elements 134 of the first mid-band column 120-1 on the second panel 112-2 are mounted on the third feedboard printed circuit board 138-3, and the middle four mid-band radiating elements 134 of the first mid-band column 120-1 on the third panel 112-3 are mounted on the fourth feedboard printed circuit board 138-4. Each of the second through fourth feedboard printed circuit boards 138-2 through 138-4 includes one or more first polarization power dividers (not shown) that split first polarization RF signals that are input thereto from the first polarization power divider 139-1 into four sub-components that are passed to the first polarization radiators of the four respective mid-band radiating elements 134 mounted thereon.

The fourth RF port 108-4 is connected to an input of a second polarization 1×3 power divider 139-2. The three outputs of the second polarization power divider 139-2 are also coupled to second through fourth feedboard printed circuit boards 138-2 through 138-4. Dotted lines are used to show these connections to make it easier to visualize the connections between the two power dividers 139 and three feedboard printed circuit boards 138-2 through 138-4. Each of the second through fourth feedboard printed circuit boards 138-2 through 138-4 includes one or more second polarization power dividers (not shown) that split second polarization RF signals that are input thereto from the second polarization power divider 139-2 into four sub-components that are passed to the second polarization radiators of the four respective mid-band radiating elements 134 mounted thereon.

Thus, RF signals output at radio port 44-1 of radio 42-2 may be transmitted into free space by the first polarization radiators of the middle four radiating elements in the first mid-band column 120-1 on each of the three reflector panels 112-1 through 112-3 to form a first omnidirectional antenna beam. Similarly, RF signals output at radio port 44-2 of radio 42-2 may be transmitted into free space by the second polarization radiators of the lowermost four radiating elements in the first mid-band column 120-1 on each of the three reflector panels 112-1 through 112-3 to form a second omnidirectional antenna beam.

Since two sector mid-band arrays 130 and two sector high-band arrays 140 are provided on each panel 112, base station antenna 100 may support 4T/4R MIMO operation at both mid-band and high-band in each sector. Since base station antenna 100 further includes four omnidirectional mid-band arrays 132 and four omnidirectional high-band arrays 142, it may also support omnidirectional 8T/8R MIMO operation at both mid-band and high-band.

As discussed above, it may be difficult to provide a large number of RF ports on a small cell antenna, such as the forty RF ports needed for base station antenna 100. While the size of the antenna could be increased to provide more room for the RF ports, or multiplexed RF ports may be used to reduce the number of RF ports, these alternatives act to increase the cost and/or degrade the performance of base station antenna 100.

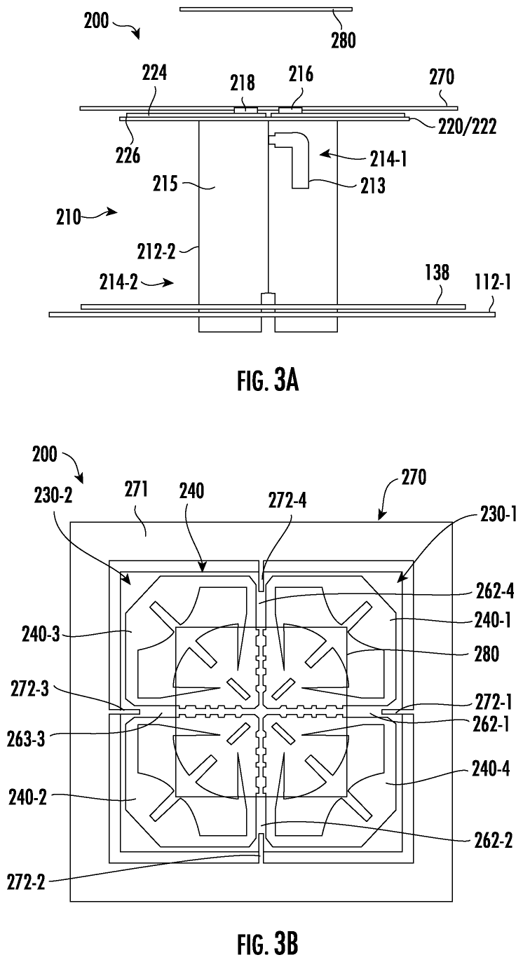

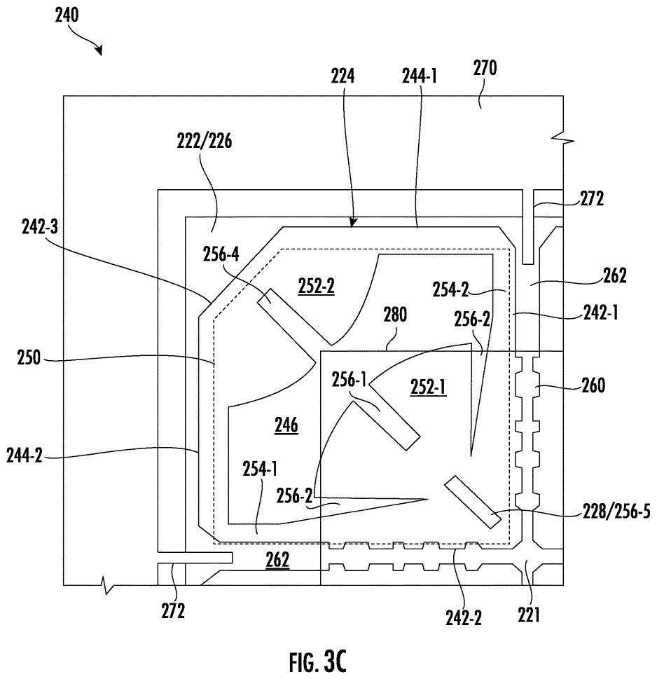

FIGS. 3A-3C illustrate an ultra-wideband radiating element 200 according to embodiments of the present invention. In particular, FIG. 3A is a schematic side view of the radiating element 200, and FIG. 3B is a schematic front view of the radiating element 200 (with a director thereof shown in shadow view). FIG. 3C is a greatly enlarged view of one of the dipole arms shown in FIG. 3B.

As shown in FIGS. 3A-3B, the radiating element 200 includes a feed stalk 210, a radiator unit 220, a coupling ring 270 and a director 280.

Referring to FIG. 3A, the feed stalk 210 may be used to mount the radiating element 200 to extend forwardly from a reflector of a base station antenna, such as reflector 112-1 of base station antenna 100. Radiating element 200 is typically mounted on a feedboard printed circuit board (e.g., feedboard printed circuit board 138 of base station antenna 100) and the feedboard printed circuit board 138 is mounted on the reflector 112-1, as shown. The radiator unit 220 is mounted on a forward or “distal” end of the feed stalk 210. The coupling ring 270 is mounted forwardly of the radiator unit 220, and may also be mounted on the feed stalk 210. The director 280 is mounted forwardly of both the radiator unit 220 and the coupling ring 270. The director 280 is typically mounted on a plastic support structure (not shown) that is mounted on either the radiator unit 220 or the coupling ring 270.

As shown in FIG. 3A, the feed stalk 210 has a longitudinal axis that extends in the forward direction and that is perpendicular to the reflector 112-1. The feed stalk 210 in the illustrated embodiment comprises first and second feed stalk printed circuit boards 212-1, 212-2. The first and second feed stalk printed circuit boards 212-1, 212-2 may be mounted in a “cross” configuration as is well known in the art. The bases of the first and second feed stalk printed circuit boards 212-1, 212-2 may be mounted in a feedboard printed circuit board 138. A first RF transmission line 214-1 is formed on the first feed stalk printed circuit board 212-1 and a second RF transmission line 214-2 is formed on the second feed stalk printed circuit board 212-2. The first RF transmission line 214-1 is used to pass RF signals between a first dipole radiator of radiating element 200 and a first polarization feed network of an antenna that includes radiating element 200, and the second RF transmission line 214-2 is used to pass RF signals between a second dipole radiator of radiating element 200 and a second polarization feed network of an antenna that includes radiating element 200. Each RF transmission line 214 may comprise a signal trace 213 and a pair of ground lines 215. It will be appreciated, however, that other types of RF transmission lines may be provided on the feed stalk 210.

In some embodiments, the feed stalk 210 may be designed to mount the radiator unit 220 about a quarter wavelength in front of a reflector, where the wavelength refers to the wavelength corresponding to the center frequency of the operating frequency band of the radiating element 100.

While the feed stalk 210 is implemented using a pair of feed stalk printed circuit boards 212-1, 212-2 in the depicted embodiment, it will be appreciated that embodiments of the present invention are not limited thereto. For example, in other embodiments, the feed stalk may be implemented using a single feed stalk printed circuit board that includes both RF transmission lines 214-1, 214-2. As another example, sheet metal feed stalks may be used in other embodiments, or the radiator unit 220 may be fed directly by a pair of coaxial cables that act as the feed stalk.

Referring to FIGS. 3B-3C, in some embodiments, the radiator unit 220 may be implemented using a printed circuit board 222 that has a single metallization layer 224 that is formed on a dielectric substrate 226. The metallization layer 224 may be formed on either the front surface or the rear surface of the dielectric substrate 226. The metallization layer 224 forms first and second dipole radiators 230-1, 230-2. The first dipole radiator 230-1 includes first and second dipole arms 240-1, 240-2, and the second dipole radiator 230-2 includes third and fourth dipole arms 240-3, 240-4.

A first pair of forwardly-projecting tabs 216 are provided at the distal end of the first feed stalk printed circuit board 212-1. These tabs 216 pass through a respective first pair of openings 228 that extend through the printed circuit board 222. Similarly, a second pair of forwardly-projecting tabs 216 are provided at the distal end of the second feed stalk printed circuit board 212-2. The tabs 216 pass through a respective second pair of openings 228 that extend through the printed circuit board 242. A metal pad 218 may be provided on each tab 216 and solder joints (not shown) may be formed that physically attach the printed circuit board 222 to the first and second feed stalk printed circuit boards 212-1, 212-2. The solder joints may also electrically connect the first and second ground lines 215 that are provided on the first feed stalk printed circuit board 212-1 and electrically connect the third and fourth ground lines 215 that are provided on the second feed stalk printed circuit board 212-2 to the respective first through fourth dipole arms 240-1 through 240-4 (only one of the ground lines 215 is visible in the figures).

Each dipole arm 240 may have a generally square perimeter when viewed from the front. The four dipole arms 240-1 through 240-4 are arranged adjacent each other to define a larger square when viewed from the front. Each dipole arm 240 has a first inner side 242-1 that is adjacent a second of the dipole arms 240, a second inner side 242-2 that is adjacent a third of the dipole arms 240, and first and second outer sides 244-1, 244-2. The inner corners defined by the inner sides 242 of each dipole arm are at a center point 221 of the radiator unit 220, with each dipole arm 240 extending outwardly from the center point 221. The outer corner of each dipole arm 240 is chamfered so that each dipole arm 240 has a third outer side 244-3 that is opposite the inner corner.

Referring to FIG. 3C, metallization is omitted in a central region 246 of each dipole arm 240 so that each dipole arm 240 forms a conductive loop 250. The metal structures forming the conductive loop 250 comprise a first metal pad region 252-1, first and second traces 254-1, 254-2 and a second metal pad region 252-2. The openings 228 in printed circuit board 222 that receive the tabs 216 on the feed stalk printed circuit boards 212 extend through the first metal pad region 252-1 of each dipole arm 240 to form fifth slots 256-5. Additionally, a first slot 256-1 where no metallization is provided extends inwardly into the first metal pad region 252-1 from an outer perimeter thereof. As shown in FIG. 3B, the first slots 256-1 of the respective dipole arms 240 may be rotationally offset from the first slots 256-1 on adjacent dipole arms 240 by −90° and 90°, respectively. For dipole arms 240-1, 240-2 of the +45° dipole radiator 230-1, the first slots 256-1 have longitudinal axes that extend at +45°. For dipole arms 240-3, 240-4 of the −45° dipole radiator 230-2, the first slots 256-1 have longitudinal axes that extend at −45°. The first metal pad region 252-1 also includes second and third slots 256-2, 256-3 that extend inwardly from the outer perimeter of each first metal pad region 252-1. The second and third slots 256-2, 256-3 are tapered slots that become narrower with increasing “depth” (i.e., distance from where the slot begins at the outer perimeter of the first metal pad region 252-1). As a result, the portions of the first metal pad region 252-1 that connect to the respective first and second traces 254-1, 254-2 are tapered so that the impedance changes gradually. This may improve the return loss performance.

The first and second traces 254-1, 254-2 may be relatively narrow traces, having average widths that are, for example, less than one-fifth an average width of the first metal pad region 252-1. Distal ends of the first and second traces 254-1, 254-2 connect to opposed sides of the second metal pad region 252-2. The second metal pad region 252-2 includes a fourth slot 256-4 where no metallization is provided. The fourth slot 256-4 extends outwardly from an inner edge of the second metal pad region 252-2. On each dipole arm 240, a longitudinal axis of the fourth slot 258-4 is aligned with a longitudinal axis of the first slot 256-1 so that the two slots 256-1, 256-4 are collinear. For the dipole arms 240-1, 240-2 of the +45° dipole radiator 230-1, the longitudinal axes of the fourth slots 256-4 extend at +45°. For the dipole arms 240-3, 240-4 of the −45° dipole radiator 230-2, the longitudinal axes of the fourth slots 256-4 extend at −45°. The lengths of the first and fourth slots 256-1, 256-4 may be configured to improve the return loss performance of radiating element 200 at higher frequency ranges.

The inner sides 242-1, 242-2 of each dipole arm 240 include a series of recesses 260 so that the inner portion of each inner side 242 has a scalloped edge. This design also helps improve the return loss performance of radiating element 200. The inner sides 242-1, 242-2 of each dipole arm 240 are spaced apart from the inner sides 242-1, 242-2 of the adjacent dipole arms 240 so that slots 262 are defined between adjacent dipole arms 240. The recesses 260 create enlarged regions within these slots 262.

While radiator unit 220 is exemplarily described as being implemented in a printed circuit board 222, embodiments of the present invention are not limited thereto. For example, in other embodiments, the radiator unit 220 may be implemented using stamped sheet metal mounted on a plastic support.

The conductive ring 270 is mounted forwardly of the radiator unit 220 in some embodiments, but may alternatively be mounted rearwardly of the radiator unit 220 in other embodiments, as will be discussed in further detail below.

The conductive ring 270 may be in close proximity to the radiator unit 220. For example, a plane defined by the conductive ring 270 may be within 1-5 mm of a plane defined by the radiator unit 220. The conductive ring 270 may surround the periphery of the radiator unit 220 when the radiating element 200 is viewed from the front. The conductive ring 270 may be a square ring that has a square outer perimeter and a square inner perimeter, as shown. First through fourth metal stubs 272-1 through 272-4 extend inwardly from the centers of the four sides of the square conductive ring 270. Each metal stub 272 may extend into a respective one of the slots 262 when the radiator unit 220 is viewed from the front. As discussed above, the radiator unit 220 and the conductive ring 270 may reside in parallel planes so that the metal stubs 272 may not physically extend into the respective slots 262 in the same plane, but instead overlap the slots 262 when the radiating element 200 is viewed from the front. By overlapping the slots 262 in the forward direction, the metal stubs 272 facilitate increased coupling between the dipole radiators 230 and the coupling ring 270. In other words, the conductive ring 270 may capacitively load the radiator unit 220. This can improve the return loss performance of radiating element 200. For example, the metal stubs 272 may improve the return loss performance by about 1 dB over the 1.9-2.7 GHz frequency range and by about 2-4 dB over the 4.1-4.2 GHz frequency band. Without the coupling ring 270, the bandwidth of radiating element 200 is 2.5-4.2 GHz. The inclusion of coupling ring 270 (with metal stubs 272) allows radiating element 200 to operate over the full 1.7-4.2 GHz frequency range.

The conductive ring 270 may be implemented as a stamped sheet metal conductive ring 270 or may be implemented using a printed circuit board. In some embodiments, the conductive ring 270 may be implemented on the same printed circuit board 222 as the radiator unit 220, and may be part of the same metallization layer or a different metallization layer of the printed circuit board 222.

The director 280 may comprise, for example, a flat piece of metal that is somewhat smaller than the radiator unit 220. A director support (not shown) may be used to mount the director 280 at a suitable distance forwardly of the radiator unit 220. The director 280 may improve the return loss performance of radiating element 200 for almost all frequencies in the 2.2-4.2 GHz range, and also increases the directivity of radiating element in the 3.1-4.2 GHz frequency band.

Referring to FIGS. 3A-3C, pursuant to embodiments of the present invention, a radiator unit 220 that comprises a first dipole radiator 230-1 that includes a first dipole arm 240-1 and a second dipole arm 240-2, and a second dipole radiator 230-2 that includes a third dipole arm 240-3 and a fourth dipole arm 240-4, and a coupling ring 270 that is adjacent the radiator unit 220. The coupling ring 270 includes a metal ring 271 and first through fourth metal stubs 272-1 through 272-4 that extend inwardly from the metal ring 271. The first dipole arm 240-1 is separated from the fourth dipole arm 240-4 by a first slot 262-1, the fourth dipole arm 240-1 is separated from the second dipole arm 240-2 by a second slot 262-2, the second dipole arm 240-2 is separated from the third dipole arm 240-3 by a third slot 262-3, and the third dipole arm 240-3 is separated from the first dipole arm 240-1 by a fourth slot 262-4. The first metal stub 272-1 overlaps the first slot 262-1 in the forward direction, a second metal stub 272-2 overlaps the second slot 262-2 in the forward direction, a third metal stub 272-3 overlaps the third slot 262-3 in the forward direction, and a fourth metal stub 272-4 overlaps the fourth slot 262-4 in the forward direction.

Each dipole arm 240 comprises a metal loop 250, and each of the first through fourth dipole arms 240-1 through 240-4 may be positioned next to two other of the first through fourth dipole arms 240-1 through 240-4 so that a perimeter defined by the first through fourth dipole arms 240-1 through 240-4 has a square shape when viewed from the front. The square shape may have beveled corners.

The coupling ring 270 may be spaced apart from the radiator unit 220 in a forward direction, and the coupling ring 270 may not overlap the first dipole radiator 230-1 or the second dipole radiator 230-2 in some embodiments. A central opening of the coupling ring may have a square shape, and the first through fourth metal stubs 272-1 through 272-4 may extend inwardly from respective first to fourth inner sides of the coupling ring 270.

The radiating element may further comprise a feed stalk 210 that has a longitudinal axis that extends in a forward direction, and the coupling ring 270 may be positioned forwardly of the radiator unit 220. The radiating element may further comprise a director 280 that may be positioned forwardly of both the radiator unit 220 and the coupling ring 270. The director 280 may not overlap the coupling ring 270 in the forward direction in some embodiments. Both the first and second dipole radiators may exhibit a return loss of less than −10 dB over the 1695-2690 MHz and the 3.1-4.2 GHz frequency bands.

As shown in FIG. 3C, each dipole arm 240 may comprise a first metal pad 252-1, a first metal trace 154-1 that extends outwardly from a first side of the first metal pad 252-1, a second metal trace 254-2 that extends outwardly from a second side of the first metal pad 252-1, the second side opposite the first side, and a second metal pad 252-2 that is positioned outwardly of the first metal pad 252-1 and electrically connected to the first metal pad 252-1 through the first and second metal traces 254-1, 254-2. An outer side of the first metal pad 252-1 may include a first slot 256-1, and an inner side of the second metal pad 252-2 may include a second slot 256-2. A longitudinal axis of the first slot 256-1 may be collinear with a longitudinal axis of the second slot 256-2. The radiating element 200 may further include a feed stalk 210, and the first metal pad 252-1 may include a fifth slot 256-5, and a tab 216 on the feed stalk 210 extends through the fifth slot 256-5. A longitudinal axis of the fifth slot 256-5 may be collinear with a longitudinal axis of the first slot 256-1. An outer side of the first metal pad 252-1 may further include first and second tapered slots 256-2, 256-3 where the metal is omitted. The first slot 256-1 may be positioned in between the first and second tapered slots 256-2, 256-3. The first slot 256-1 has a first length, and the first and second tapered slots each have a second length that is longer than the first length.

Still referring to FIGS. 3A-3C, pursuant to further embodiments of the present invention, a radiating element 200 is provided that comprises a radiator unit 220 that comprises a first dipole radiator 230-1 that comprises a first dipole arm 240-1 and a second dipole arm 240-2 and a second dipole radiator 230-2 that comprises a third dipole arm 240-3 and a fourth dipole arm 240-4. Each dipole arm 240 may comprise a first metal pad 252-1, a first metal trace 254-1 that extends outwardly from a first side of the first metal pad 252-1, a second metal trace 254-2 that extends outwardly from a second side of the first metal pad 252-1, the second side opposite the first side, and a second metal pad 252-2 that is positioned outwardly of the first metal pad 252-1 and that is electrically connected to the first metal pad 252-1 through the first and second metal traces 254-1, 254-2.

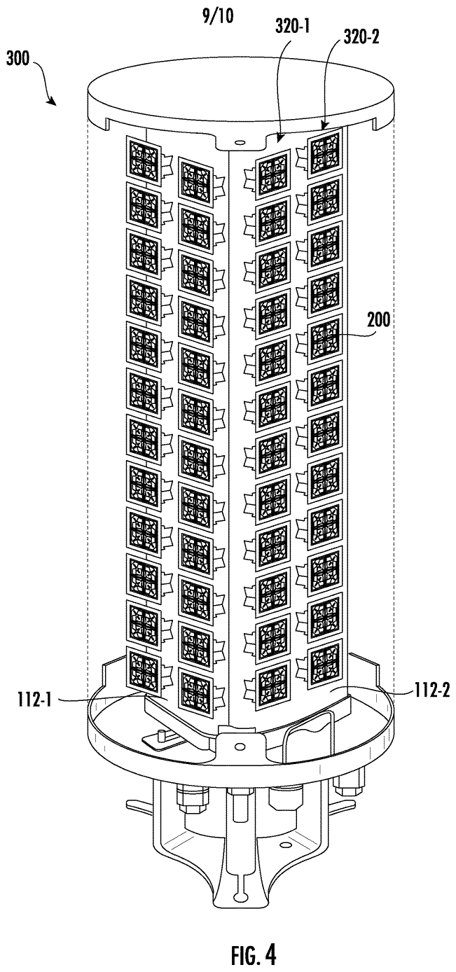

FIG. 4 is a schematic perspective view of a small cell base station antenna 300 according to embodiments of the present invention with its radome removed. Base station antenna 300 is similar to conventional base station 100 of FIGS. 2A-2C, and has the same capabilities. Base station antenna 300 differs from base station antenna 100 in that base station antenna 300 includes two columns 320-1, 320-2 of ultra-wideband radiating elements 200 on each panel 112 in place of the two columns 120-1, 120-2 of mid-band radiating elements 134 and the two columns of 122-1, 122-2 of high-band radiating elements 144 on each panel 112 that are included in base station antenna 100. The columns 320 of ultra-wideband radiating elements 200 are used to form both the mid-band and the high-band arrays of base station antenna 100. Base station antenna 300 also includes a plurality of diplexers (not shown) that are used to route received mid-band and high-band RF signals to the appropriate mid-band and high-band feed networks and to combine the mid-band and high-band RF signals that are provided to the radiating elements 200 for transmission.

While FIG. 4 illustrates one base station antenna 300 in which the ultra-wideband radiating elements according to embodiments of the present invention may be used, it will be appreciated that the ultra-wideband radiating elements disclosed herein may be used in a wide variety of different base station antennas. For example, the ultra-wideband radiating elements disclosed herein may be used in macrocell sector base station antennas. As another example, the ultra-wideband radiating elements disclosed herein may be used in small cell base station antennas that have backplanes with more than three facers such as small cell antennas having backplanes that have, for example, four, six, eight, twelve or sixteen faces.

As can be seen by comparing FIGS. 2A and 4, base station antenna 300 may have a smaller diameter than base station 100 while spacing adjacent columns 120 of radiating elements 200 farther apart than are adjacent columns 120, 122 of radiating elements 134, 144 in base station 100. Base station antenna 300 also has a total of thirty-six radiating elements 200, while base station antenna 100 has a total of eighty radiating elements 134, 144. Because of these differences base station antenna 300 may have reduced cost and improved performance as compared to base station antenna 100.

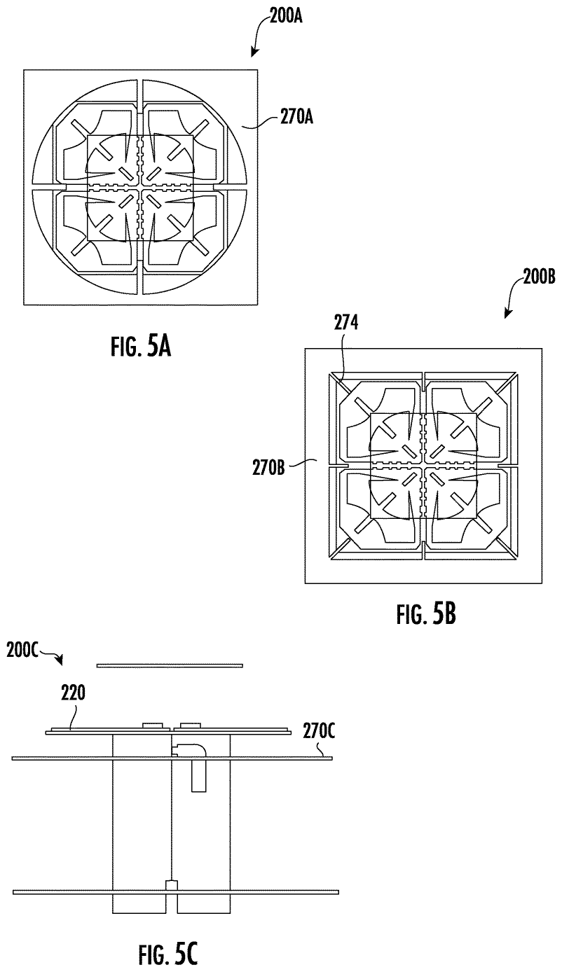

FIG. 5A is a schematic side view of an ultra-wideband radiating element 200A according to still further embodiments of the present invention. Radiating element 200A is very similar to radiating elements 200, with the only difference being that the coupling ring 270A of base station antenna 200A has a circular inner perimeter.

As shown in FIG. 5A, pursuant to further embodiments of the present invention, a radiating element 200A is provided that comprises a feed stalk 210, a radiator unit 220 mounted on a forward end of the feed stalk 210, the radiator unit 220 comprising a first dipole radiator 230-1 that includes a first dipole arm 240-1 and a second dipole arm 240-2, and a second dipole radiator 230-2 that comprises a third dipole arm 240-3 and a fourth dipole arm 240-4. Radiating element 200A further comprises a coupling ring 270A that has an outer perimeter that has a first shape when viewed from the front and a central opening that has a second shape when viewed from the front, where the second shape is different than the first shape. The first shape may be, for example, a square. The second shape may be, for example, a circle. In other embodiments, the second shape may be an octagon. In still other embodiments, the first shape may be a circle, a hexagon or an octagon and the second shape may be a square.

FIG. 5B is a schematic side view of an ultra-wideband radiating element 200B according to still further embodiments of the present invention. Radiating element 200B is identical to radiating elements 200, except that the conductive ring 270B in radiating element 200B further includes fifth through eighth metal stubs 272-5 through 272-8 that extend inwardly from the metal ring 271. The fifth through eighth metal stubs 272-5 through 272-8 extend inwardly from inner corners of the metal ring 271 at angles of −/+45°. The fifth through eighth metal stubs 272-5 through 272-8 may further improve the return loss performance, at least in certain portions of the 1.7-4.2 GHz frequency range. In still further embodiments, the conductive ring may include the fifth through eighth metal stubs 272-5 through 272-8 and omit the first through fourth metal stubs 272-1 through 272-4.

FIG. 5C is a schematic front view of an ultra-wideband radiating element 200C according to still further embodiments of the present invention. Radiating element 200C is very similar to radiating elements 200, with the only difference being that the coupling ring 270 is positioned rearwardly of the radiator unit 220 in base station antenna 200C, whereas coupling ring 270 of radiating element 200 is positioned forwardly of the radiator unit 220. Thus, further description of base station antenna 200C will be omitted here.

The present invention has been described above with reference to the accompanying drawings. The invention is not limited to the illustrated embodiments; rather, these embodiments are intended to fully and completely disclose the invention to those skilled in this art. In the drawings, like numbers refer to like elements throughout. Thicknesses and dimensions of some elements may not be to scale.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

1. A radiating element, comprising:
a radiator unit that comprises a first dipole radiator that comprises a first dipole arm and a second dipole arm and a second dipole radiator that comprises a third dipole arm and a fourth dipole arm;
a coupling ring adjacent the radiator unit, the coupling ring including a metal ring and a first through fourth metal stubs that extend inwardly from the metal ring,
wherein the first dipole arm is separated from the fourth dipole arm by a first slot, the fourth dipole arm is separated from the second dipole arm by a second slot, the second dipole arm is separated from the third dipole arm by a third slot, and the third dipole arm is separated from the first dipole arm by a fourth slot, and
wherein the first metal stub overlaps the first slot in the forward direction, the second metal stub overlaps the second slot in the forward direction, the third metal stub overlaps the third slot in the forward direction, and the fourth metal stub overlaps the fourth slot in the forward direction.

2. The radiating element of claim 1, wherein each of the first through fourth dipole arms comprises a metal loop, and each of the first through fourth dipole arms is positioned next to two other of the first through fourth dipole arms so that a perimeter defined by the first through fourth dipole arms has a square shape when viewed from the front.

3. The radiating element of claim 2, wherein the square shape has beveled corners.

4. The radiating element of claim 1, wherein the coupling ring is spaced apart from the radiator unit in a forward direction, and the coupling ring does not overlap the first dipole radiator or the second dipole radiator in the forward direction.

5. The radiating element of claim 1, wherein a central opening of the coupling ring has a square shape, and the first through fourth metal stubs extend inwardly from respective first to fourth inner sides of the coupling ring.

6. The radiating element of claim 5, further comprising fifth through eighth metal stubs that extend inwardly from the respective first to fourth inner sides of the coupling ring.

7. The radiating element of claim 6, wherein the first through eighth metal stubs have longitudinal axes that extend inwardly at angles of 0°, 45°, 90°, 135°, 180°, −135°, −90° and −45°, respectively.

8-10. (canceled)

11. The radiating element of claim 1, further comprising a director mounted forwardly of the radiator unit and the coupling ring.

12-21. (canceled)

22. A radiating element, comprising:
a feed stalk;
a radiator unit mounted on a forward end of the feed stalk, the radiator unit comprising a first dipole radiator that comprises a first dipole arm and a second dipole arm and a second dipole radiator that comprises a third dipole arm and a fourth dipole arm; and
a coupling ring that has an outer perimeter that has a first shape when viewed from the front and a central opening that has a second shape when viewed from the front,
wherein the second shape is different than the first shape.

23-24. (canceled)

25. The radiating element of claim 22, wherein the first dipole arm is separated from the second dipole arm by a first slot, the second dipole arm is separated from the third dipole arm by a second slot, the third dipole arm is separated from the fourth dipole arm by a third slot, and the fourth dipole arm is separated from the first dipole arm by a fourth slot.

26. The radiating element of claim 25, wherein the coupling ring includes a ring section and first through fourth metal stubs that extend inwardly from the ring section, wherein the first metal stub overlaps the first slot in the forward direction, the second metal stub that overlaps the second slot in the forward direction, the third metal stub that overlaps the third slot in the forward direction, and the fourth metal stub that overlaps the fourth slot in the forward direction.

27. The radiating element of claim 26, the coupling ring further comprising fifth through eighth metal stubs that extend inwardly from the inner sides of the ring section.

28-32. (canceled)

33. A radiating element, comprising:
a radiator unit that comprises a first dipole radiator that comprises a first dipole arm and a second dipole arm and a second dipole radiator that comprises a third dipole arm and a fourth dipole arm;
wherein the first dipole arm comprises:
a first metal pad;
a first metal trace that extends outwardly from a first side of the first metal pad;
a second metal trace that extends outwardly from a second side of the first metal pad, the second side opposite the first side; and
a second metal pad that is positioned outwardly of the first metal pad and electrically connected to the first metal pad through the first and second metal traces.

34. The radiating element of claim 33, wherein an outer side of the first metal pad includes a first slot, and an inner side of the second metal pad includes a second slot.

35. The radiating element of claim 34, wherein a longitudinal axis of the first slot is collinear with a longitudinal axis of the second slot.

36. The radiating element of claim 35, further comprising a feed stalk, where the radiator unit is mounted on the feed stalk, and wherein the first metal pad includes a third slot, and a tab on the feed stalk extends through the third slot.

37. The radiating element of claim 36, wherein a longitudinal axis of the third slot is collinear with a longitudinal axis of the first slot.

38. The radiating element of claim 34, wherein an outer side of the first metal pad further includes first and second tapered slots where metal is omitted, and wherein the first slot is in between the first and second tapered slots.

39. The radiating element of claim 38, wherein the first slot has a first length, and the first and second tapered slots each have a second length that is longer than the first length.

40. The radiating element of claim 33, further comprising a metal coupling ring that is configured to capacitively couple with the first dipole radiator and the second dipole radiator.

41-47. (canceled)
